(19) United States
(12) Patent Application Publication
(10) Pub. No.: US 2007/0043547 A1
(43) Pub. Date: Feb. 22, 2007

(54) Integrated debugging environment for a network simulation

(76) Inventors: Jerome Plun, Alexandria, VA (US); Alexey Shakula, Reston, VA (US); Sukanya Sreshta, Rockville, MD (US)

Correspondence Address: ROBERT M. MCDERMOTT, ESQ., 1824 FEDERAL FARM ROAD, MONTROSS, VA, 22520, US

(21) Appl. No.: 11/506,650

(22) Filed: Aug. 18, 2006

Related U.S. Application Data
(60) Provisional application No. 60/709,777, filed on Aug. 19, 2005.

(51) Int. Cl. G06F 17/50

(52) U.S. Cl. 703/13; 715/853

(57) ABSTRACT

Generating a user interface for debugging a network simulation based on modeled network behavior by providing a user interface (UI) to depict both of a high level element and a low level element based on the simulation. The high level element may be presented in a hierarchical view representing a hierarchy of elements. The hierarchical view may be provided in a tree-view based on one of a topology or taxonomy of elements within the simulated network or the hierarchy of elements may be based on a simulation hierarchy of elements within the simulated network. An invoking element may be depicted higher in the hierarchical view than an element invoked by the invoking element. Both high and low level commands may be issued from an integrated command line.

This application claims the benefit of U.S. Provisional Patent Application No. 60/709,777, filed Aug. 19, 2005.

### BACKGROUND AND SUMMARY OF THE INVENTION

The present system relates to the field of simulating network properties and behavior and particularly to an interface to facilitate debugging of a simulation.

A network is composed of a set of components, each with some associated behavior and properties. A discrete event simulation of such a network is a software program whose execution represents as much of the network's components' properties and behavior as necessary for the simulation's purpose. As such, modeling network communications typically involves simulating a large number of components with properties and behavior. In the case of incorrect results, one needs to “debug” the simulation by analyzing these components during simulation execution.

Debugging the simulation's behavior typically involves a review and analysis of the actions of a large number of simulated network components. Furthermore the processes that are executed in the simulation are typically programmed using a high level programming language such as C, C++, Java, or other high level programming language of the like where one can inadvertently express incorrect behavior. However, to track down issues in these processes during the simulation, one often has to investigate their behavior at the programming instruction level. However, prior systems typically require debugging either at the event level (high level) or the source level (low level) using text-based debuggers.

It is an object of the present system to overcome disadvantages and/or make improvements in the prior art.

The present system includes a system, method and device for generating a user interface for debugging a network simulation. In operation, a network is simulated based on modeled network behavior. A user interface (UI) is provided to depict both of a high level element and a low level element based on the simulation. The high level element may be presented in a hierarchical view representing a hierarchy of elements. The hierarchical view may be provided in a tree-view. The hierarchy of elements may be based on a topological hierarchy of elements within the simulated network. In one embodiment, the hierarchy of elements may be based on a taxonomy of elements within the simulated network or the hierarchy of elements may be based on a simulation hierarchy of elements within the simulated network. An invoking element may be depicted higher in the hierarchical view than an element invoked by the invoking element.

Within the hierarchical view, selectable levels of simulation detail may be provided. The high level element may be provided with a visual characteristic that distinguishes that high level element from another high level element that is a different type of high level element. For example, the high level element may be provided with a visual characteristic that indicates that the high level element is an active element in the simulation. For example, an active element may be an element currently undergoing an action within the simulation, such as processing a data packet

In one embodiment, a first simulation trace may be depicted and stored as the high level element. Thereafter, a change may be received in the modeled network behavior from a user and the network may be simulated based on the changed network behavior. A second simulation trace may thereafter be created based on the simulation of the changed network behavior. The UI may provide a comparison of the first simulation trace to the second simulation trace. A visual indication may be provided of a difference between the first and second simulation traces.

The high and low level elements may be updated dynamically as the simulation progresses. A selection of a particular high level element may result in a display of a further low level element based the selected high level element. A low level breakpoint may be conditioned in the simulation based on a high level characteristic present at some point in the simulation. In an alternate embodiment, in response to a high level breakpoint in the simulation, the UI may depict the low level element based on a portion of the simulation present at a time of the high level breakpoint. In one embodiment, an integrated command line structure is provided wherein both high and low level commands may be entered within a single command line.

### BRIEF DESCRIPTION OF THE DRAWINGS

The invention is explained in further detail, and by way of example, with reference to the accompanying drawings wherein:

FIG. 1 shows a high level hierarchical view provided in accordance with an embodiment of the present system;

FIG. 2 shows a portion of a UI that depicts low level elements in accordance with an embodiment of the present system;

FIG. 3 shows a portion of a UI that may be provided combining high level elements and low level elements within the UI in accordance with an embodiment of the present system;

FIG. 4 shows a UI in accordance with an embodiment of the present system that may operate as an integrated front end for a high level debugger and may be operated to step through simulation events and display simulation components;

FIG. 5 shows a portion of a UI that may be provided combining high level elements and low level elements within the UI in accordance with an embodiment of the present system;

FIG. 6 shows a portion of a UI that may be provided combining high level elements and low level elements within the UI in accordance with a further embodiment of the present system;

FIG. 7 illustrates how a combination of high and low level information may be combined into a UI in accordance with the present system;

FIG. 8 shows a composite view of a GUI in accordance with an embodiment of the present system; and

FIG. 9 shows a device in accordance with an embodiment of the present system.

### DETAILED DESCRIPTION

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, etc. However, it will be apparent to those of ordinary skill in the art that other embodiments that depart from these details would still be understood to be within the scope of the appended claims. Moreover, for the purpose of clarity, detailed descriptions of well-known devices, circuits, and methods are omitted so as not to obscure the description of the present system.

It should be expressly understood that the drawings are included for illustrative purposes and do not represent the scope of the present system. In the accompanying drawings, like reference numbers in different drawings may designate similar elements. The present system may depict different portions of a simulation including components being simulated, processes, sub-processes, variables, stack data, states of components, etc., all of which may be depicted in various portions of the system in accordance with the present system. Accordingly, for purposes of simplifying a description, the term “element” as utilized herein is intended to include all of the above and other related portions of a simulation that may be advantageously displayed unless explicitly or implicitly stated otherwise.

The system and method described herein address problems in prior art systems. In accordance with the present system, event level and source level debugging tools and information are provided within a user interface (UI). The UI may be provided by an application running on a computer. The visual environment is displayed by the computer on a display device and a user is typically provided with an input device to influence events or images depicted on the display. UI's present visual images which describe various visual metaphors of an operating system, an application, etc. implemented on the computer.

The user typically moves a user-controlled object, such as a cursor or pointer, across a computer screen and onto other displayed objects or screen regions, and then inputs a command to execute a given selection or operation. Other applications or visual environments also may provide user-controlled objects such as a cursor for selection and manipulation of depicted objects in either of a two-dimensional or three-dimensional space.

The user interaction with and manipulation of the computer environment is achieved using any of a variety of types of human-computer interface devices that are connected to the computer controlling the displayed environment. A common interface device for UI's is a mouse, trackball, keyboard, etc. A mouse is moved by a user in a planar workspace to move an object such as a cursor on the two-dimensional display screen in a direct mapping between the position of the user manipulation and the position of the cursor. This is typically known as position control, where the motion of the object directly correlates to motion of the user manipulation.

An example of such a UI is a UI for interaction within a debugging environment to assist a user, such as a network administrator, to debug a network simulation. Through use of the user interface in accordance with the present system, for example provided as a graphical user interface (GUI), use of network debuggers, such as text-based symbolic debuggers, is simplified in that simulated network components may be readily identified and viewed before, during and after the simulation. The present system facilitates access to information about specific high level and low level elements and enhances an ability to pinpoint the cause of incorrect behavior in the simulation.

In accordance with an embodiment, an object browser may be provided that displays network elements in a hierarchical fashion. For example, the hierarchy may be based on topology (e.g., child-of) indicating an interconnection relationship of network elements, such as simulated network components. In another embodiment, the hierarchy may be based on taxonomy (e.g., is-a), for example, indicating a similarity of component types within the hierarchy. In any event, the hierarchical display may enable the user to control the amount of detail provided in the UI view, such as within a simulation trace. For example, the information may be displayed using a tree-view of elements to enable the user to select how much detail to display on each branch. A default setting may show only top level elements. In one embodiment, details of a currently active component (e.g., a node currently processing a data packet) may be displayed to enable a view of a flow of processing throughout a simulation. As may be readily appreciated, other views such as a hierarchical view of the processing flow may also be readily applied.

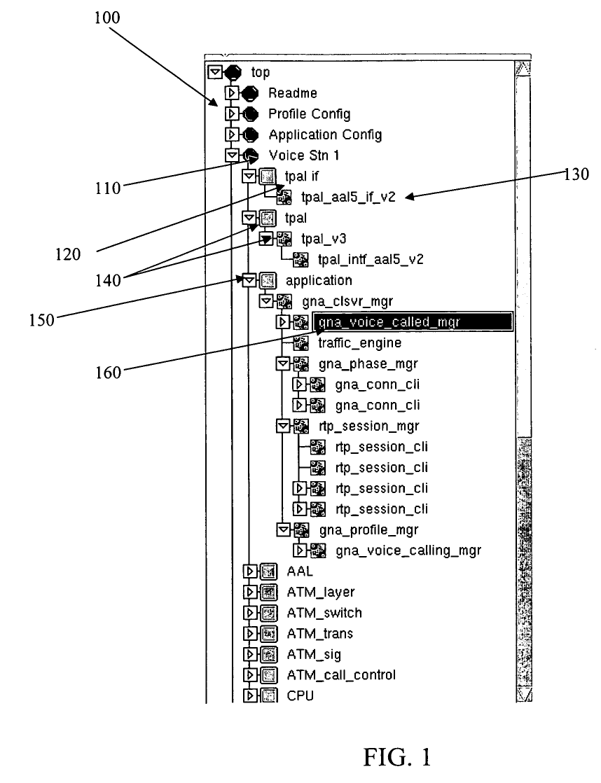

FIG. 1 shows an illustrative embodiment of a portion of user interface including a topology based hierarchical tree-view 100, illustratively showing high level network components in accordance with the present system. For example, the hierarchy may include network elements, such as network element (e.g., component) “Voice Stn 1” 110, processing elements (e.g., processing components) making up each element, such as processing component “tpal if” 120, and actual processes associated with each element, such as process “tpal_intf_aal5_if_v2” 130. For simplicity of discussion, the objects of the hierarchical networks will be discussed in terms of elements which may readily correspond to nodes, servers, processes, etc. unless explicitly or implicitly stated otherwise. As shown, iconic depictions 140 may be utilized to provide a visual differentiation between levels of the hierarchy as well as providing an indication of a particular type of element (e.g., different devices) within the hierarchy. An indication 150 may be provided to enable the user to control an amount of information presented. Selection of the indication 150 may result in more or less detail of a related hierarchy being provided for a given element. In this way, the user may be able to focus in on particular elements without being distracted by elements that are not of interest.

The hierarchical view provided in FIG. 1 may also be utilized to indicate other portions of the simulation. For example, in another embodiment, a trace of a simulation execution may be displayed as the hierarchical structure. In this embodiment, the hierarchical structure may be utilized to indicate which high level functions of the simulation have invoked other functions. For example, a branch of the hierarchy may depict an invoking function as a base of the tree with an invoked function depicted as a branch off the base. The hierarchical display may again enable the user to control the amount of detail provided in the trace. An indication, such as a change in color of an element, change in iconic depiction, or other visual indication may be provided in the hierarchical view, or other view, to visually indicate what portion of a depicted view is actively being processed within the simulation. For example, a depicted high level element, such as a node within a view that is processing a data packet may change color from other surrounding nodes to indicate that it is active. Similarly, for a view that is depicting processing steps, highlighting 160 may be utilized to indicate a current process in the simulation. As would be readily appreciated by a person of ordinary skill in the art, the hierarchical structure of the present system may be utilized to depict other features of the simulation and are intended to be encompassed by the present system.

A hierarchical trace of a simulation may also be saved for future reference or comparison to a current trace. In this way, portions of the high and/or low level description may be altered and simulated for comparison to a simulation trace made prior to the alteration. The comparison may be facilitated in accordance with an embodiment of the present system in that a difference between simulations may be depicted utilizing an indication, such as the highlighting 160. Further, elements such as parameters that resulted in a difference in the simulation may also be provided in a portion of the UI to facilitate a distinction being made between simulations. Other visualizations may be provided in accordance with the present system to facilitate identifying differences between two executions of the simulation.

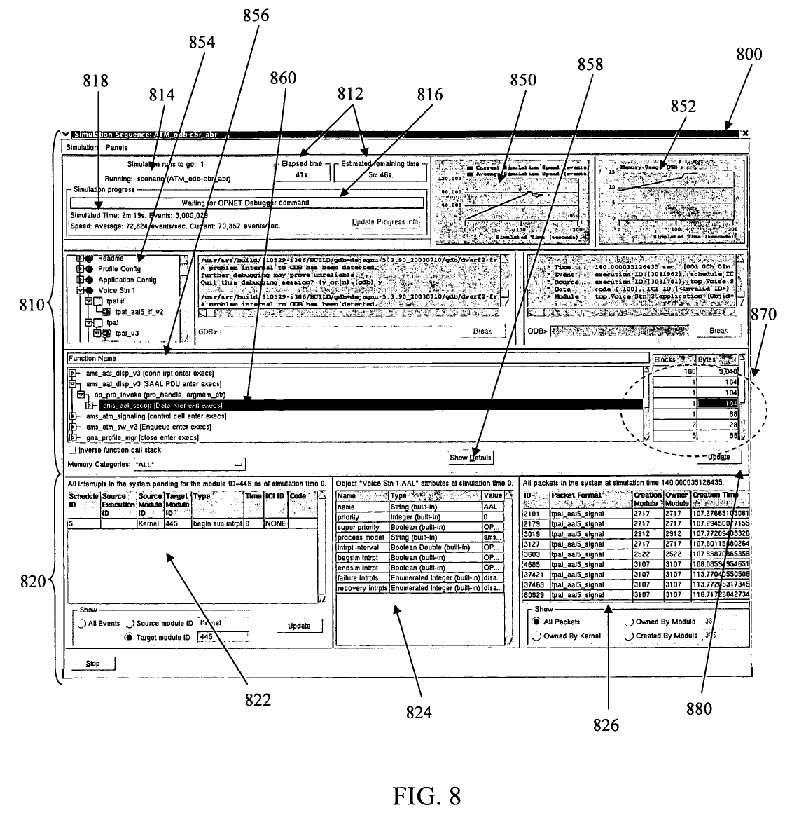

In accordance with an embodiment, the hierarchy 100 may be updated dynamically as components are created or destroyed during the course of the simulation. In addition, the UI in accordance with the present system may be utilized to provide low level information based on depicted high level information. For example, current properties or attributes (low level information) of an element in the hierarchy 100 (high level information) may be displayed as desired. In one embodiment, “right-clicking” on an element depicted in the hierarchy 100 may provide a pop-up menu with a menu selection to display current attributes of the element. In addition, a button (e.g., see button 858 of FIG. 8 discussed hereinafter) may be provided, either as an actual button or a metaphor of a button within the UI, to provide further details of a selected element (e.g., see indication 860 of FIG. 8).

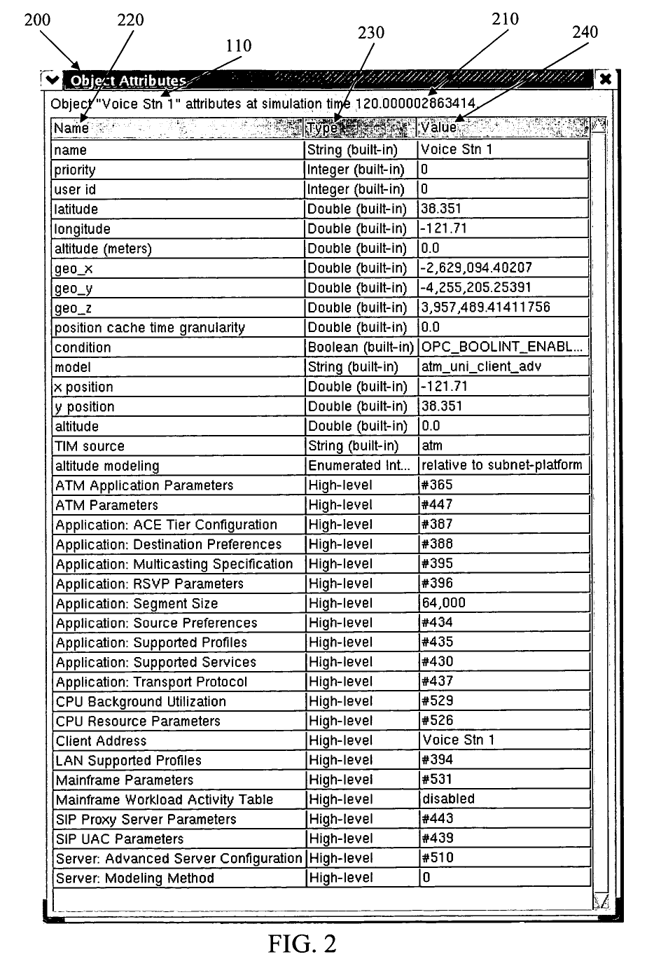

FIG. 2 shows a UI 200 that may be produced as a result of a request to display current attributes (e.g., low level element) of the element “Voice Stn 1” 110 shown in FIG. 1. The attributes depicted in the UI 200 are dynamically updated based on the simulation progress and as such, the UI 200 indicates a current simulation time 210. The attributes indicated may include an attribute name 220, attribute type 230, and a current value 240 of the attribute. Similarly, a status of related interrupts may be provided during the simulation process. In another embodiment, a graphical display of simulation elements may be provided as high level elements during the simulation within the UI 200 including a flow of packets between the simulation elements, information on event execution, and other low level simulation information of the like.

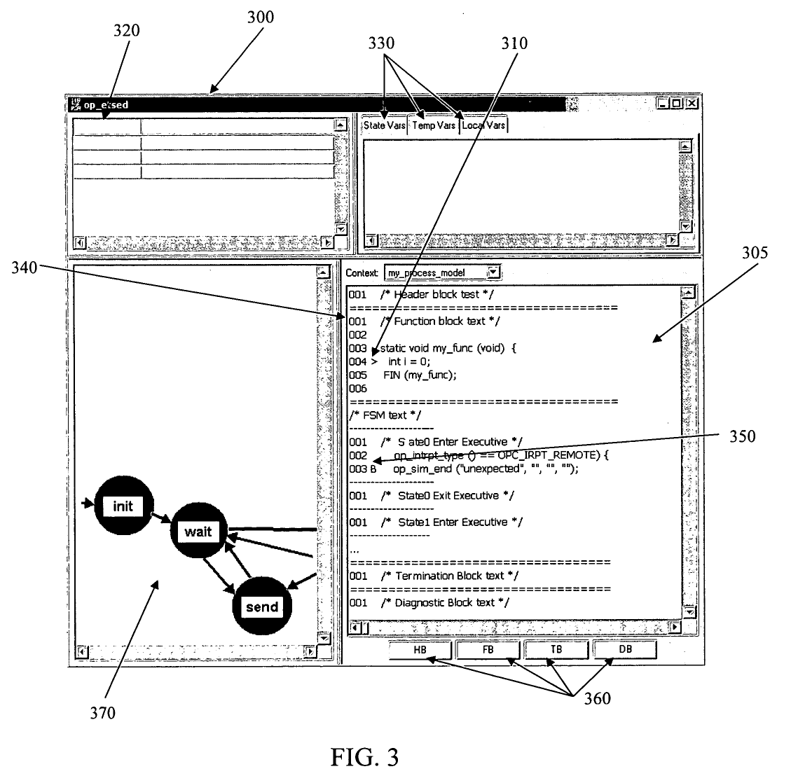

Advantageously, the present system enables a display of execution progress and data in a high level context which generally is easier for a user to follow thereby simplifying a debugging process. This allows the display of symbolic information about an element in the context of the high level debugger, without requiring the user to manually perform the conversion from a high level reference (e.g., modeled in C/C++) to a low level representation. So for example one can select a process from the hierarchical view shown in FIG. 1 and generate a graphical display showing the current state of that process at a low level, such as at the level of currently executing programming instructions as illustratively shown in a UI view 300 shown in FIG. 3.

FIG. 3 shows the UI 300 depicting a current state of execution at a low level, namely at an assembly code level, as illustratively provided in an area 305. As such, the view 300 has an indication (e.g., caret, highlighting, change in color, etc.) 310 showing a current assembly instruction of the simulation. An area 320 may include values that have been pushed to a function call stack of the simulation or attribute names and values provided to enable a user to view and optionally modify the low level values during simulation. Other low level elements, such as variable states 330 may be examined during simulation in this view 300. In one embodiment, line numbers 340 of the programming instructions may be provided relative to each other within a segment as shown. In another embodiment, line numbers 340 may be displayed that are absolute within the simulation itself. An indication 350 is provided to identify simulation breakpoints which may be added and/or deleted at any time before, during, or after the simulation within this UI 300. Buttons 360 may provide or hide details of blocks of simulation instructions to enable a focus on blocks of interest. Area 370 further provides a high level graphical state diagram that is representative of the various simulation states. The state diagram may be dynamically updated to indicate the present state of the simulation.

As such, the present system may operate as a front-end for a low level symbolic debugger that may step through the low level representation of the network simulation, such as assembly code or instructions of a programming language, and display low level data such as the programming variables 330. Accordingly, the present system enables stepping through an execution of one or more processes associated with network elements. In this way, the state of these processes as execution progresses may be reviewed and/or altered.

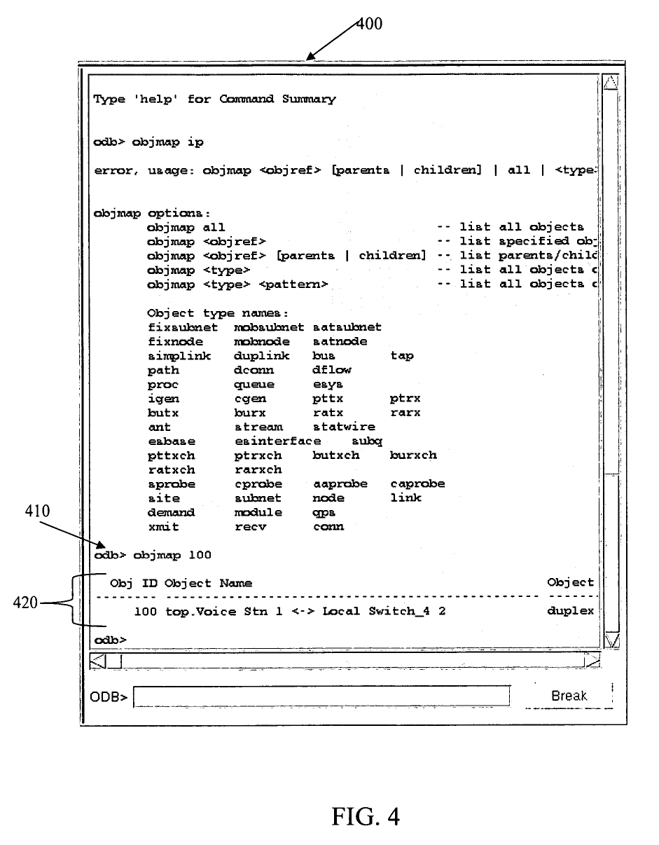

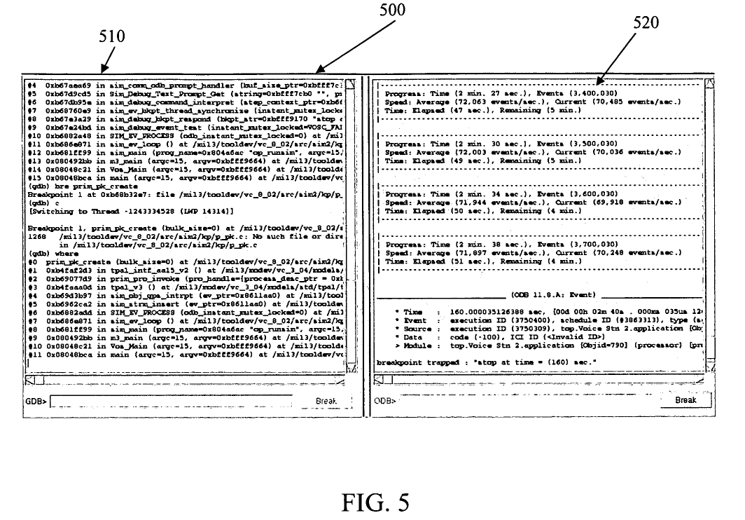

FIG. 4 shows a UI 400 in accordance with an embodiment of the present system that may operate as an integrated front end for a high level debugger and may be operated to step through simulation events and display simulation elements. As such, the UI 400 provides a command line 410 for entering high level commands related to portions of the network being simulated (e.g., site, subnet, node, link). The UI 400 also enables acting on simulation components or data packets. Commands entered through the command line 410 of the UI may be provided to a running simulation for example by being passed to a high or low level debugging back end. Results of the simulation and the output of the commands may also be displayed in an appropriate fashion within an area 420 of the UI 400. In one embodiment, the command line 410 may combine both of high level commands and low level commands into a single command line. In this way, instructions for both of the high and low level debuggers may be issued within the same command line resulting in depiction of a UI having both of related high and low level elements, such as for example shown in FIG. 5.

FIG. 5 shows an integrated UI 500 having both of low level (e.g., symbolic) and high level (e.g., event) debugging information views 510, 520. Providing both of the symbolic and high level views 510, 520 of debuggers within a single UI 500 enables simple simulation debugging wherein, for example, instructions issued at one level (e.g., high level) may be simulated and monitored at another level (e.g., low level). Due to a modular nature of many low level portions of a simulation, it may be difficult to identify where in a simulation a particular action, such as a breakpoint, is desired. In operation, often multiple element (e.g., object module) instances in the domain of the simulation may have the same source-code level implementation, such as C/C++, Java, or others of the like, that defines the element's behavior. Accordingly, implementation of a breakpoint, for example, at the low level may result in a breakpoint being executed for each instance of the object when a breakpoint only at a particular instance of the object is desired. In accordance with an embodiment of the present system, a source-code level breakpoint may be conditioned to a particular module instance by taking into account a high level characteristic present at a time around when the breakpoint is desired, such as when the simulation is accessing a runtime memory location. Naturally other high level runtime structures may be associated with a particular module in which the breakpoint is desired. By a specification of breakpoints in the symbolic debugger based on elements of the high level debugger, a more precise application of programming constraints, such as breakpoints, may be achieved. In this way, the present system may enable a control of constraints, such as breakpoints, not only at the source-code level which is the implementation of the module behavior, but also at the simulation domain level so that the breakpoint is active only for a subset of module instances that share a particular set of source code. For example, this enables one to stop the simulation when a given element is activated, with the high level debugger providing the symbolic debugger with the appropriate set of conditions to only stop for the appropriate component instance instead of activating the breakpoint for all instances of that component.

Conversely, setting a high level constraint such as a breakpoint in the simulation based on a processing element (e.g., when a specific high level event is about to be executed), enables the user to not only stop at the event-level to perform high level operations, but also enables the user to see the source code view of the active process at that instant of processing within the UI 500 provided in accordance with an embodiment of the present system. Accordingly, in the illustrative embodiment shown in the UI 500, the high level view 520 of the simulation (e.g., simulation event) and the low level view (e.g., actual C and/or C++ functions involved in the execution of the event) are provided within a single UI, namely the UI 500.

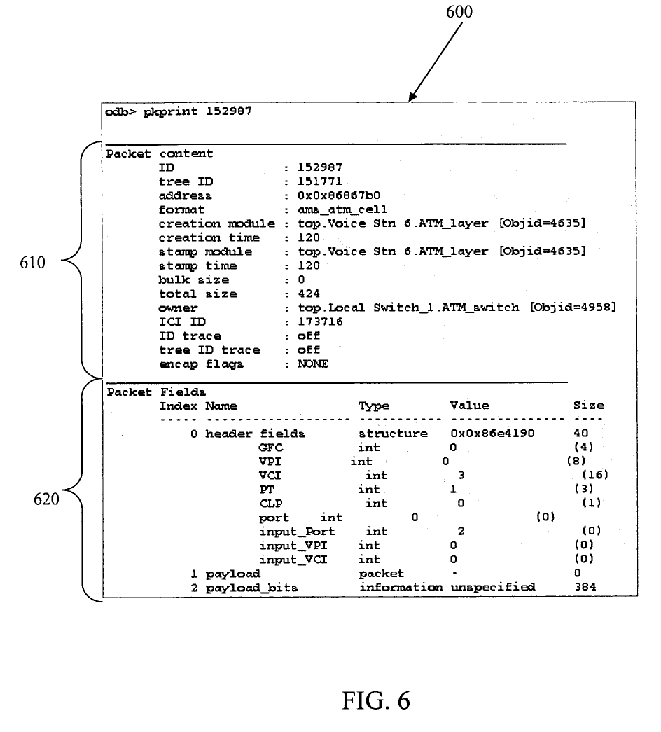

In another embodiment depicted in FIG. 6 in accordance with the present system, a graphical display is provided within a UI 600 that depicts both high and low level simulation data. High level data may include data elements used by simulation components, such as packets. Low level data may include the data in each field of that packet. For example, the UI 600 in accordance with an embodiment of the present system may provide a high level status for a simulation process, such as a packet, in a first portion 610 of the UI 600. A second portion 620 of the UI 600 may be utilized to provide low level details about the element (e.g., process) depicted in the first portion 610. For example, the second portion 620 may provide low level information, such as variables associated with the process or processes depicted in the first portion 610. The integration of high level and related low level data in accordance with the present system combines the provided information into a more practical output. The UI 600 combines the high level view for example of a packet, and the information that a low level debugger may provide, for example, related to arbitrary C and/or C++ structures stored as fields of a packet. In this embodiment of a UI in accordance with the present system, the display of packet data in the high level view provided in the first portion 610 and the integration of low level debugger results in the second portion 620

provides more flexibility for identifying elements of the simulation and associated data. The combination of both high level debugging data and low level debugging data within a single UI provides numerous opportunities to readily gain insight into a current simulation without requiring separately entering and exiting high and low level debuggers during the simulation process.

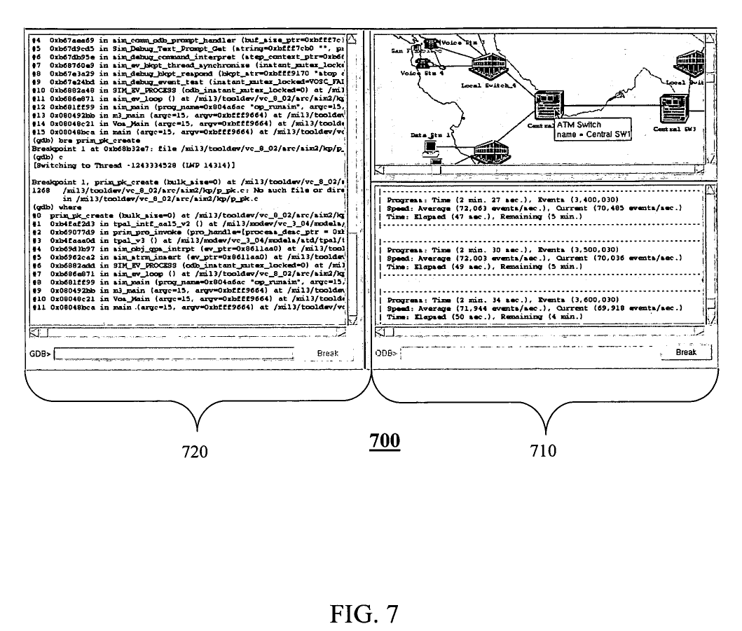

FIG. 7 illustrates how a combination of high and low level information may be combined into a UI 700 in accordance with the present system. UI 700 illustrates how by providing both high level and low level simulation information within a single UI, a much simplifier form of debugging the simulation is provided. UI 700 shows a graphical display of a flow of data between simulation components during the course of the simulation. For example, the UI 700 may show network components, simulation time, number of processed events, etc. in a first portion 710 depicting high level information related to the simulation, while low level information, such as queued up packets, active processes, etc. is provided in a second area 720 of the UI 700.

FIG. 8 shows a composite view of a GUI 800 in accordance with an embodiment of the present system. As such, the GUI 800 illustrates how multiple views may be integrated together to enable ready interaction with a simulation at either or both of a high level and a low level. Illustratively, the UI 800 includes a first portion 810 wherein high level information related to the simulation may be provided including simulation status information such as elapsed and remaining simulation time 812 for a given process 814, debugger status 816, total simulation time 818, simulation speed as a function of simulation time 850, memory usage as a function of simulation time 852 of the simulation, network elements 854, simulation functions 856 and other high level information of the like. The UI 800 also includes a second portion 820 wherein low level information related to the simulation may be provided including pending interrupts 822, attributes 824, packet information 826, and other low level information of the like.

In accordance with an embodiment of the present system, interaction with one portion of the UI 800, such as the first portion 810, may result in a change in displayed information in the same portion and/or a change in displayed information in another portion such as the second portion 820. For example, the indication 860 may be provided to identify an element in the first portion 810 that is currently active. Selection of the button 858 may change a part of the first portion 810, such as an area 870 and/or may change a part of the depicted second portion 820, such as one or more of elements 822, 824, 826. A button 880 may be provided to update an element based on a current simulation event if any of the elements of the UI 800 are not being updated dynamically.

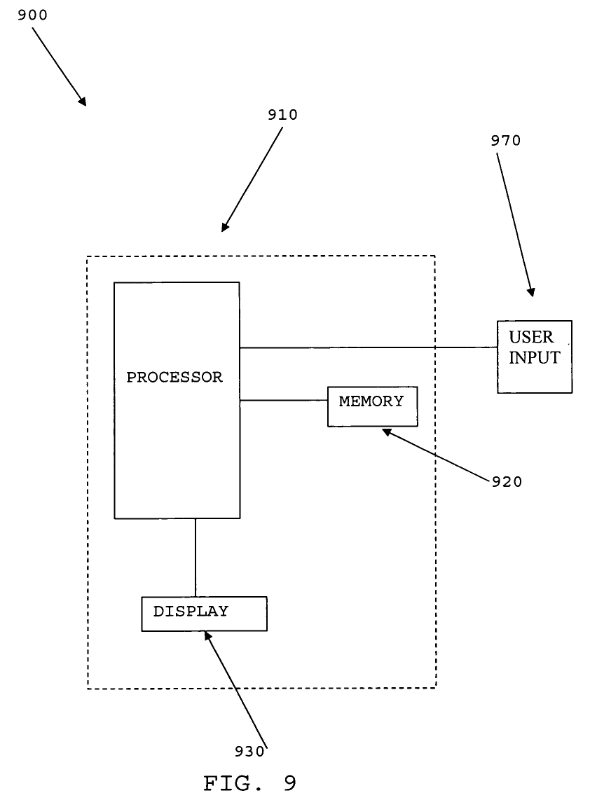

FIG. 9 shows a device 900 in accordance with an embodiment of the present system. The device has a processor 910 operationally coupled to a memory 920, a display 930 and a user input device 970. The memory 920 may be any type of device for storing application data, such as simulation data as well as other data, such as attribute data, simulation event data, stack data, etc. The application data and other data are received by the processor 910 for configuring the processor 910 to perform operation acts in accordance with the present system. The operation acts include controlling at least one of the display 930 to display content such as the UIs 100, 200, 300, 400, 500, 600, 700, 800. The user input 970 may include a keyboard, mouse, trackball or other devices, including touch sensitive displays, which may be stand alone or be a part of a system, such as part of a personal computer, personal digital assistant, or other display device for communicating with the processor 910 via any type of link, such as a wired or wireless link. The user input device 970 is operable for interacting with the processor 910 including interaction within a paradigm of a UI, selection and/or altering of high level elements, low level elements, algorithms, parameters, and/or other elements of the present system. Clearly the processor 910, memory 920, display 930 and/or user input device 970 may all or partly be a portion of a computer system or other device.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 920 and/or other memory coupled to the processor 910.

The computer-readable medium and/or memory 920 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, or a wireless channel using time-division multiple access, code-division multiple access, or other radio-frequency channel). Any medium known or developed that can store and/or transmit information suitable for use with a computer system may be used as the computer-readable medium and/or memory 920.

Additional memories may also be used. The computer-readable medium, the memory 920, and/or any other memories may be long-term, short-term, or a combination of long-term and short-term memories. These memories configure processor 910 to implement the Uls, methods, operational acts, and functions disclosed herein. The memories may be distributed or local and the processor 910, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 920, for instance, because the processor 910 may retrieve the information from the network for operation in accordance with the present system.

The processor 910 is capable of providing control signals and/or performing operations in response to input signals from the user input device 970 and executing instructions stored in the memory 920. The processor 910 may be an application-specific and/or general-use integrated circuit(s). Further, the processor 910 may be a dedicated processor for performing in accordance with the present system and/or may be a general-purpose processor wherein only one of many functions operates for performing in accordance with the present system. The processor 910 may operate utilizing a program portion, multiple program segments, and/or may be a hardware device utilizing a dedicated or multi-purpose integrated circuit.

Of course, it is to be appreciated that any one of the above embodiments or processes may be combined with one or more other embodiments or processes or be separated in accordance with the present system. As should be clear, the present system enables a user to model network operation including network communications such as simulating a large number of elements with properties and behavior. The present system further provides a ready system for debugging the simulation by providing a UI for both providing ready access to both high level and low level debugging information related to these elements during a simulation. The present system provides a graphical environment that simplifies the use of high and low level debuggers, such as text-based symbolic debuggers, in the context of the network elements and thereby, facilitates access to information about specific elements and enhances the ability to debug incorrect behavior in the simulation.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements can be as few as two elements, and can include an immeasurable number of elements.

What is claimed is:

1. A method of generating a user interface for debugging a network simulation comprising the acts of:
simulating a network based on modeled network behavior; and
providing a user interface (UI) depicting both of a high level element and a low level element based on the simulation.

2. The method of claim 1, wherein the high level element is presented in a hierarchical view representing a hierarchy of elements based on one of a topological hierarchy and taxonomy of elements within the simulated network.

3. The method of claim 2, wherein the high level element is presented in a hierarchical view representing a hierarchy of elements based on a simulation hierarchy of elements within the simulated network, and wherein providing the user interface comprises an act of depicting an invoking element higher in the hierarchical view than an element invoked by the invoking element.

4. The method of claim 1, comprising acts of:
receiving high and low level commands from an integrated command line; and
producing corresponding high and low level functions, wherein the UI is provided in response to the produced functions.

5. The method of claim 1, wherein the high level element is a simulation event.

6. The method of claim 5, wherein the low level element is a programming code listing related to a current simulation event.

7. The method of claim 1, wherein the low-level element is one of an attribute, a parameter, and a state of interrupts based on a current simulation time and the high level element.

8. The method of claim 1, wherein providing the user interface comprises an act of providing the high level element with a visual characteristic that distinguishes the high level element from another high level element that is a different type of high level element.

9. The method of claim 1, wherein providing the user interface comprises an act of providing the high level element with a visual characteristic that indicates that the high level element is an active element.

10. The method of claim 1, wherein providing the user interface comprises an act of creating a first simulation trace as the high level element, the method comprising the acts of:
storing the first simulation trace;
receiving a change in the modeled network behavior;
simulating the network based on the changed network behavior; and
creating a second simulation trace based on the simulation of the changed network behavior.

11. The method of claim 10, comprising an act of providing a UI for comparing the first simulation trace to the second simulation trace.

12. The method of claim 11, wherein the act of providing the user interface for comparing the first simulation trace to the second simulation trace comprises an act of providing a visual indication of a difference between the first and second simulation traces.

13. The method of claim 1, wherein the high and low level elements are updated dynamically as the simulation progresses.

14. The method of claim 1, comprising acts of:
receiving selection of a particular high level element; and
displaying a further low level element based the particular high level element.

15. The method of claim 1, comprising an act of conditioning a low level constraint in the simulation based on a high level characteristic present at some point in the simulation.

16. The method of claim 1, comprising an act of responding to a high level constraint in the simulation, wherein the act of providing the user interface comprises an act of depicting the low level element based on a portion of the simulation present at a time of the high level constraint.

17. An application embodied on a computer readable medium arranged to debug a network simulation, the application comprising:
a first portion arranged to simulate a network based on modeled network behavior; and
a second portion arranged to provide a display of a high level element and a low level element based a result of the simulation.

18. The application of claim 17, comprising a third portion arranged to provide a low level debugging function to produce the displayed low level element.

19. The application of claim 17, comprising a third portion arranged to provide a high level debugging function to produce the displayed high level element.

20. The application of claim 19, wherein the third portion is arranged to display the high level element as a hierarchical view representing a hierarchy of elements.

21. The application of claim 20, wherein the hierarchy of elements is based on a simulation hierarchy of elements within the simulated network, and wherein the second portion is arranged to depict an invoking element higher in the hierarchical view than an element invoked by the invoking element.

22. The application of claim 17, wherein the second portion is arranged to depict a simulation state diagram as the high level element.

23. The application of claim 17, wherein the second portion is arranged to depict parameters relating to a current simulation state as the low level element.

24. The application of claim 17, wherein the second portion is arranged to display at least one of debugger status, total simulation time, memory usage, and network elements as the high level element and at least one of pending interrupts, attributes, packet information, and programming code as the low level element.

25. The application of claim 17, comprising a third portion arranged to receive combined high and low level commands from an integrated command line and produce corresponding high and low level functions, wherein the second portion provides the display in response to the produced functions.

26. The application of claim 17, wherein the second portion is arranged to display the high level element with a visual characteristic that distinguishes the high level element from another high level element that is a different type of high level element.

27. The application of claim 17, comprising:
a third portion arranged to store a first simulation trace as the high level element; and
a fourth portion arranged to produce a second simulation trace based on a change in modeled network behavior.

28. The application of claim 27, comprising a fifth portion arranged to display a comparison of the first simulation trace to the second simulation trace.

29. The application of claim 17, comprising:
a third portion arranged to receive a selection of a particular high level element; and
a fourth portion arranged to display a further low level element based the particular high level element.

30. The application of claim 17, comprising a third portion arranged to condition a low level constraint in the simulation based on a high level characteristic present at some point in the simulation.

31. The application of claim 17, comprising a third portion arranged to respond to a high level constraint in the simulation, wherein the second portion is arranged to produce the low level element based on a portion of the simulation present at a time of the high level constraint.
